(19) United States
(12) Patent Application Publication
(10) Pub. No.: US 2006/0057302 A1
(43) Pub. Date: Mar. 16, 2006

(54) Process for coating a web with a coating powder

(76) Inventors: Juha Maijala, Jarvenpaa (FI); Kaisa Putkisto, Tampere (FI); Jyrki Hakola, Jarvenpaa (FI); Johan Gron, Espoo (FI); Juha Lipponen, Jarvenpaa (FI)

Correspondence Address: STIENNON & STIENNON, 612 W. MAIN ST., SUITE 201, P.O. BOX 1667, MADISON, WI, 53701-1667, US

(21) Appl. No.: 10/534,294

(22) PCT Filed: Nov. 14, 2003
(86) PCT No.: PCT/FI03/00867

§ 371 Date: Sep. 13, 2005

(30) Foreign Application Priority Data
Nov. 14, 2002 (FI) 20022034

(51) Int. Cl. B05D 1/04

(52) U.S. Cl. 427/475

(57) ABSTRACT

The surface of a web is coated with a dry coating powder. The coating powder has inorganic material and polymeric binder material. The polymeric binder material is selected in such a manner that when increasing the temperature above the glass transition temperature the ratio G″/G′ is at the most equal to the ratio G″/G′ in the glass transition temperature.

### CROSS REFERENCES TO RELATED APPLICATIONS

This application is a U.S. national stage application of international app. No. PCT/FI2003/000867, filed Nov. 14, 2003, the disclosure of which is incorporated by reference herein, and which claims priority on Finnish Application No. 20022034, Filed Nov. 14, 2002.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to a method for coating a surface of a web, which fibrous portion consists of papermaking fibers, with a coating powder comprising the steps of:
selecting raw materials of the coating powder comprising inorganic material and polymeric binder material, the polymeric binder material having a characteristic glass transition temperature T_{g} above which a rubbery state plateau exists, and a dynamic modulus, which consists of a measurable elastic component G′ and a measurable loss component G″,
forming the coating powder from the raw materials,
allowing the web to move between electrodes, which are in different potentials,
applying the coating powder on the surface of the web by utilizing the difference in the electric potential, and
finishing the coated surface of the web in a process step in which the process is arranged to achieve its maximum temperature, which exceeds the glass transition temperature T_{g} of the polymeric binder material.

A dry surface treatment process is a known method in which dry coating powder is applied on a web. The coating powder includes inorganic material and polymeric binder material. A problem related to coating by the dry surface treatment process is a behavior of the polymeric binder material during the process. The viscoelastic properties of polymers depend on the temperature and frequency of deformation. On the one hand, the polymeric binder material should soften and form a film at least partially in certain process conditions because otherwise the cohesion strength of the powder-formed layer and its adhesion to the web is insufficient. On the other hand, the softened polymeric binder material must not adhere to counter surfaces with which it is in contact during the process.

### SUMMARY OF THE INVENTION

The method of the invention overcomes the above-mentioned problems. It is characterized in that the polymeric binder material is selected in such a manner that when increasing the temperature above the glass transition temperature the ratio G″/G′ is at the most equal to the ratio G″/G′ in the glass transition temperature.

When the ratio G″/G′ is at the most 1 in the rubbery plateau the polymeric binder material does not adhere to the counter surfaces during processing. Energy and costs can be saved in the process because polymeric binder materials having a low glass transition temperature (in other words, materials having a low softening temperature) can be used. Also shorter dwell times can be used in the process.

The present invention is utilized in a dry surface treatment process in which a web is allowed to move between electrodes, which are in different potentials. The coating powder is electrically charged by at least one electrode at one side of the web, and charged particles of the coating powder are applied on the surface of the web by utilizing an electric field, which is created between the electrode at the one side of the web and at least one electrode at the other side of the web. The potential difference between the electrodes can be created by electrodes having opposite polarities, or by an electrode being either positive or negative and a ground electrode. After a coating layer has been formed on the web the coated surface of the web is finished by using heat and pressure in such a manner that the polymeric binder material at least partially melts. In the finishing step the process achieves its maximum temperature.

The preferred ranges for the thermomechanical treatment are: The temperature of 80-350° C., the linear load of 25-450 kN/m and the dwell time of 0.1-100 ms (speed 150-2500 m/min; nip length 3-1000 mm; in one passage). The thermomechanical treatment can be made by various calendering methods or calendering-like methods. The methods utilize nips formed between rolls, or substantially long nips formed between two counter surfaces. Examples of such nips are hard-nip, soft-nip, long-nip (e.g. shoe-press or belt calender), Condebelt-type calender and super-calender.

The fibrous portion of the continuous web to be treated consists of papermaking fibers. In the present application, the papermaking fibers refer to fibers obtained from trees, in other words, either fibers of a mechanical or chemical pulp or mixtures of those two.

The coating powder includes inorganic particles (e.g. ground CaCO₃, precipitated CaCO₃, kaolin, talc, TiO₂ etc.) and polymeric binder particles. Suitable polymeric materials for polymeric binder particles are for example styrene-butadiene or acrylate copolymers. The polymeric binder material may comprise several polymers, and its characteristics may be modified. The inorganic particles and the polymeric binder particles can be separate particles, or an inorganic portion and a polymeric portion may be integrated into same particles. The average diameter of the material particles is usually 0.1-500 μm, preferably 1-15 μm.

The coating powder comprises 10.1-99.5 wt-% (dry weight) of inorganic material and the rest is preferably polymeric binder material. The coating powder comprises preferably at least 70 wt.-% of inorganic material and more preferably at least 80 wt.-% of inorganic material. The coating powder comprises preferably at the most 99 wt.-% of inorganic material and more preferably at the most 95 wt.-% of inorganic material.

For a known polymer composition that includes an amorphous phase, there is a known or characteristic range of temperatures where the glass transition takes place. This transition region, which with increasing temperature corresponds to a change in the mechanical properties of the material, is generally described as a change from glassy to rubbery state. The glass transition temperature, which can be taken characteristic for each type of polymers, but is affected e.g. by chemical means, is usually determined in a static state. Exerting a dynamic deformation into the material shifts the transition temperature towards higher temperatures.

The viscoelastic behavior of a material determines a flowing ability of a material. Mechanical properties of viscoelastic material under dynamic loading can be denoted by the elastic and viscous components of the dynamic modulus, which for example in torsional deformation mode are the shear storage modulus G′ and shear loss modulus G″.

The ratio G″/G′ is called a loss factor, which typically reaches its maximum in the glass transition temperature. Above the glass transition temperature there is a range called a rubbery state plateau. In the rubbery state plateau the loss factor changes less. Typically, the loss factor in the rubbery state plateau does not exceed a level, which is at the most 80% from the level, which is reached in the glass transition temperature. In general a level corresponding to 50% of the glass transition temperature level is not exceeded. For polymeric binder materials, which have a distinct melting point Tₘ, the rubbery state plateau can be defined as a range between the glass transition temperature and the melting point. For materials not having a distinct melting point, the rubbery state plateau can be defined simply as a rubbery state.

The finishing step in the thermomechanical treatment causes deformations in the coating layer. The deformation properties of the whole coating are affected by e.g. the binder selection and content, additives and interactions between the binder and the pigments. When the web is not loaded (e.g. compressed) any more, some of the deformations recover and some last (permanent change). The ratio G″/G′ measured for the binder indicates the formation of permanent changes within the material under deformational stresses.

The properties of the properly selected polymeric binder material during the dry surface treatment process can be described as follows: When the elastic component G′ of the dynamic modulus remains stable at high enough level and the ratio G″/G′ is 1 at the most in the rubbery state plateau, the adhesion of the polymeric binder material to the counter surfaces during processing is diminished. In other words, the elastic component G′ shall be higher or at least equal to the loss component G″ above the softening temperature of the polymeric binder material. The loss factor may be almost constant, or slightly increasing or decreasing. Preferably the loss factor is constant and maintains steady in range 0.2-1.0, or more preferably in range 0.2-0.6 when measured at elevated temperatures and conditions corresponding to the processing. The elastic modulus (the shear storage modulus) of the polymeric binder material is preferably at least 1.0×10⁵ Pa when measured at fixed conditions corresponding the thermomechanical treatment. This high elasticity typically requires polymer crosslinking to some degree. Hence, the polymeric binder material is selected in such manner that when increasing the temperature above the glass transition temperature the ratio G″/G′ is at the most equal to the ratio G″/G′ in the glass transition temperature. The glass transition temperature is determined in the same conditions as the loss factor. Preferably at measuring conditions corresponding to the dry surface treatment finishing step the ratio G″/G′ is at the most 1 in the rubbery state plateau. More preferably the ratio G″/G′ is at the most 1 between the glass transition temperature of the polymeric binder material and the maximum processing temperature (the temperature in the coating material).

The viscoelastic properties during a thermomechanical treatment can be determined according to ASTM D5279-01 in the following manner: An even film of 1 to 3 mm in thickness is manufactured from a polymeric binder material. The film is put under torsional stress, and at the same time the film is allowed to move through a specific temperature range. As the viscoelastic properties vary between measuring conditions, it is important to specify the conditions in each case. The used temperature range was −30-130° C. and the temperature rise 3° C./min. The used frequency was 1 Hz. The torsional loading created shearing in the material with an adjusted strain of 16% (in relation to a full circle).

In the following, the invention is explained by referring to figures.

### BRIEF DESCRIPTION OF THE DRAWINGS

FIGS. 1 and 2 show curves representing an elastic modulus and a loss factor as a function of temperature.

### DESCRIPTION OF THE PREFERRED EMBODIMENTS

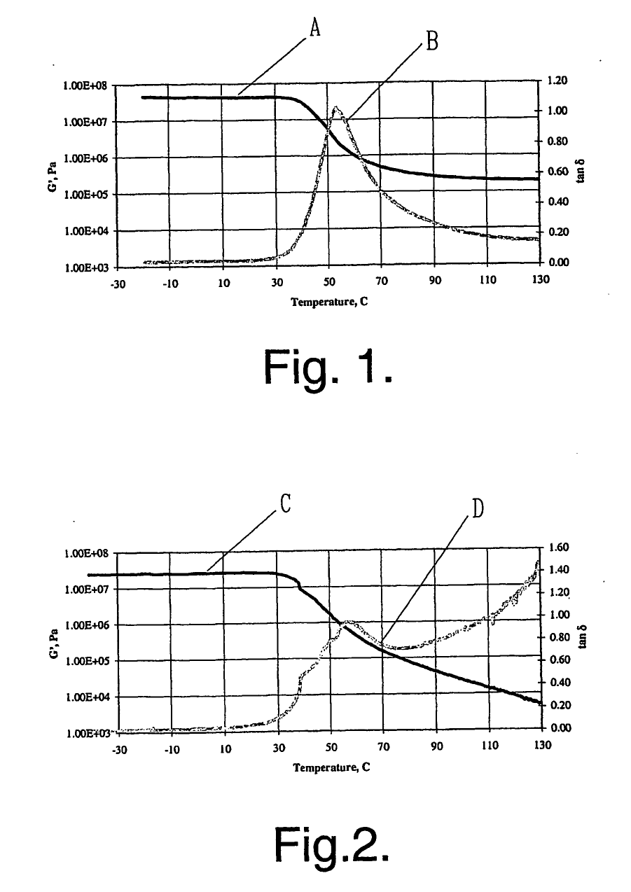

In FIG. 1, the elastic component G′ of the shear modulus is represented by a curve A, and the loss factor G″/G′ is represented by a curve B. The curves show properties of a polymeric binder material, which has acceptable characteristics for use in the dry surface treatment process. The elastic modulus is at least 1.0×10⁵ Pa, and the loss factor is at the most 1. The characteristic glass transition temperature of the material is 24° C. (measured in the static state). However, a peak in the curve B representing the glass transition temperature has been shifted towards higher temperatures due to a dynamic measurement method.

In FIG. 2, the elastic component G′ of the shear modulus is represented by a curve C, and the loss factor G″/G′ is represented by a curve D. The curves show properties of a polymeric binder material, which has no acceptable characteristics for use in the dry surface treatment process. The elastic modulus is below 1.0×10⁵ Pa when the temperature exceeds 75° C., and the loss factor is over 1 when the temperature exceeds 110° C. The characteristic glass transition temperature of the material is 24° C. It is very probable that this polymeric binder material disadvantageously sticks onto surfaces during processing.

The invention is not restricted to embodiments explained above but it may vary in the scope of the claims.

1-6. (canceled)

7. A method for coating a surface of a web comprising papermaking fibers with a coating powder, comprising the steps of:
forming a coating power from a selected inorganic material and a polymeric binder material, wherein the step of forming comprises selecting the polymeric binder material such that it has a characteristic glass transition temperature and exhibits a rubbery state plateau above the characteristic glass transition temperature, and at the glass transition temperature the selected polymeric binder material defines a dynamic modulus, which has a first elastic component G′ and a first loss component G″, wherein the ratio between the first loss component G″ and the first elastic component G′ defines a first loss factor, and wherein when the selected polymeric binder material is heated above the characteristic glass transition temperature, the selected polymeric binder material defines a second dynamic modulus, which has a second elastic component G′ and a second loss component G″ wherein the ratio between the second loss component G″ and the second elastic component G′ defines a second loss factor, and wherein the second loss factor is less than or equal to the first loss factor when the temperature is in the a rubbery state plateau;
moving the web between electrodes which are in different potentials;
applying the coating powder on the surface of the web by utilizing the difference in the electric potential; and
finishing the coated surface of the web in a process which reaches a maximum process temperature greater than the characteristic glass transition temperature of the selected polymeric binder material.

8. The method of claim 7, wherein the second loss factor is at the most one in the rubbery state plateau.

9. The method of claim 7, wherein the second loss factor is at the most one between the glass transition temperature and the maximum process temperature.

10. The method of claim 7, wherein the elastic modulus component is at least 1.0×10⁵ Pa in a temperature range which is below the maximum process temperature.

11. The method of claim 7, wherein the second loss factor in the rubbery state plateau is at the most 80 percent of the value of the first loss factor.

12. The method of claim 11, wherein the second loss factor in the rubbery state plateau is at the most 50 percent of the value of the first loss factor.

13. A method of formulating a paper coating and applying the coating to a paper web comprising the steps of:
selecting a polymeric binder based on the criteria that the polymeric binder has the following properties:
a characteristic glass transition temperature,
a rubbery state plateau above the characteristic glass transition temperature,
a dynamic modulus, which has an elastic component and a loss component, wherein the ratio of the loss component to the elastic component defines a loss factor, wherein the loss factor of the polymeric binder at a temperature above the glass transition temperature and in the rubbery state plateau is less than or equal to the loss factor at the glass transition temperature; and
combining the selected polymeric binder with a selected inorganic material and forming a coating powder therefrom;
moving the paper web between two electrodes at different potentials;
applying the coating on the surface of the paper web by utilizing the difference in potential of the two electrodes; and
heating the paper web and the coating on the surface of the paper web in a nip formed between two rolls, or in a long nip formed between two counter surfaces, to a process temperature of between 80-350° C., at a linear load of between 25-450 kN/m and at a dwell time of between 0.1-100 ms; and wherein the process temperature is above the characteristic glass transition temperature.

14. The method of claim 13, wherein the loss factor is at most one between the glass transition temperature and the maximum process temperature.

15. The method of claim 13, wherein the elastic modulus component is at least 1.0×10⁵ Pa in a temperature range which is below the maximum process temperature.

16. The method of claim 13, wherein the loss factor in the rubbery state plateau is at the most 80 percent of the value of the loss factor at the glass transition temperature.

17. The method according to claim 16, wherein the loss factor in the rubbery state plateau is at the most 50 percent of the value of the loss factor at the glass transition temperature.
